(19) United States
(12) Patent Application Publication
(10) Pub. No.: US 2026/0260482 A1
(43) Pub. Date: Sep. 3, 2026

(54) INFORMATION PROCESSING APPARATUS AND CONTROL METHOD

(71) Applicant: Panasonic Intellectual Property Management Co., Ltd., Osaka (JP)

(72) Inventors: Hiroaki SUDO, Kanagawa (JP); Masato MIYAKAWA, Kanagawa (JP); Masanori MURABAYASHI, Kanagawa (JP)

(73) Assignee: Panasonic Intellectual Property Management Co., Ltd., Osaka (JP)

(21) Appl. No.: 19/551,158

(22) Filed: Feb. 26, 2026

(30) Foreign Application Priority Data
Feb. 28, 2025 (JP) 2025-031575
Oct. 20, 2025 (JP) 2025-176619

(51) Int. Cl. G06V 10/98; G06V 10/25; G06V 20/52; G06V 40/20

(52) U.S. Cl. CPC G06V 10/987; G06V 10/25; G06V 20/52; G06V 40/20

(57) ABSTRACT

An information processing apparatus includes: a detector, which in operation, detects to which region an article has moved during an operation in which a customer moves the article placed in a first region to a second region, registers the article at a registration apparatus, and moves the article from the second region to a third region; and a controller, which in operation, performs, when it is detected that the customer has not registered a first article in the second region, control that presents first information to the customer until completion of movement of the first article to the third region is detected.

### CROSS REFERENCE TO RELATED APPLICATIONS

This application is entitled to (or claims) the benefit of Japanese Patent Application No.2025-031575, filed on February 28, 2025, and Japanese Patent Application No.2025-176619, filed on October 20, 2025, the disclosure of which including the specification, drawings and abstract is incorporated herein by reference in its entirety.

### Technical Field

The present disclosure relates to an information processing apparatus and a control method.

### Background Art

In recent years, the popularity of self-checkout has rapidly increased in order to reduce the number of staff in retail stores and the like. In the self-checkout, since the customer himself/herself performs the barcode scanning of a product, it is important to take measures against fraudulent acts such as shoplifting in which the customer takes a product without paying the price of the product.

For example, Patent Literature (hereinafter, referred to as "PTL") 1 discloses that, when it is determined that a product is taken out of a shopping cart, image data captured by a recognition camera is acquired and analyzed to determine whether the product is placed in a storage bag, and when it is determined that the product is placed in the storage bag, whether the barcode of the product is read and scanned by a barcode scanner between the shopping cart and a conducting wire of the storage bag, and when it is determined that the product is not scanned between the shopping cart and the conducting wire of the storage bag, an error warning is notified.

### Citation List

### Patent Literature

PTL 1

Japanese Patent Application Laid-Open No. 2011-054038

### SUMMARY OF INVENTION

However, as in PTL 1, when it is determined whether the product is scanned after it is determined that the product is placed in the storage bag, and the error warning is notified, the customer may not notice the error warning in time, so that the measure against the fraudulent act may not be sufficient.

One non-limiting exemplary embodiment of the present disclosure facilitates providing an information processing apparatus and a control method each capable of quickly making a notification of a fraudulent act.

### Solution to Problem

An information processing apparatus according to one exemplary embodiment of the present disclosure includes: a detector, which in operation, detects to which region an article has moved during an operation in which a customer moves the article placed in a first region to a second region, then registers the article at a registration apparatus, and moves the article from the second region to a third region; and a controller, which in operation, performs, when it is detected that the customer has not registered a first article in the second region, control that presents first information to the customer until completion of movement of the first article to the third region is detected.

A control method according to one exemplary embodiment of the present disclosure includes: detecting, by an information processing apparatus, to which region an article has moved during an operation in which a customer moves the article placed in a first region to a second region, registers the article at a registration apparatus, and moves the article from the second region to a third region; and performing, by the information processing apparatus, when it is detected that the customer has not registered a first article in the second region, control that presents first information to the customer until completion of movement of the first article to the third region is detected.

Note that general or specific embodiments may be implemented as a system, an apparatus, a method, an integrated circuit, a computer program, a storage medium, or any selective combination thereof.

### Advantageous Effects of Invention

According to one embodiment of the present disclosure, it is possible to quickly make a notification of a fraudulent act.

Additional benefits and advantages of the disclosed embodiments will become apparent from the specification and drawings. The benefits and/or advantages may be individually obtained by the various embodiments and features of the specification and drawings, which need not all be provided in order to obtain one or greater of such benefits and/or advantages.

### BRIEF DESCRIPTION OF DRAWINGS

FIG. 1 is a diagram illustrating a configuration example of a self-checkout register system;

FIG. 2 is a diagram illustrating an example of a system configuration including a plurality of self-checkout registers;

FIG. 3 is a diagram illustrating an example of a processing state of a register and a transition thereof;

FIG. 4 is a diagram illustrating Example 1 of a transition of display on a display;

FIG. 5 is a diagram illustrating Example 2 of a transition of display on a display;

FIG. 6 is a diagram illustrating Example 3 of a transition of display on a display;

FIG. 7A is a diagram illustrating an exemplary area setting;

FIG. 7B is a diagram illustrating an exemplary area setting;

FIG. 8 is a diagram illustrating an example of a provisional determination and a final determination;

FIG. 9 is a diagram illustrating an example of a flow of the provisional determination and the final determination;

FIG. 10 is a diagram illustrating an exemplary display on a display;

FIG. 11 is a diagram illustrating an exemplary transition from display of a provisional determination;

FIG. 12 is a flowchart illustrating Example 1 of a flow of processing executed in an information processing apparatus;

FIG. 13 is a diagram illustrating an example of extension of a provisional determination;

FIG. 14 is a diagram illustrating an example of alert display;

FIG. 15 is a flowchart illustrating Example 2 of a flow of processing executed in an information processing apparatus; and

FIG. 16 is a block diagram illustrating a configuration example of an information processing apparatus.

### DESCRIPTION OF EMBODIMENTS

Hereinafter, an embodiment of the present disclosure will be described in detail with reference to the drawings as appropriate. However, a more than necessary detailed explanation may be omitted. For example, detailed explanation of already well-known matters or duplicate explanation of substantially the same configuration may be omitted. This is to avoid the following explanation becoming unnecessarily redundant and to facilitate understanding by those skilled in the art.

Note that the accompanying drawings and the following description are provided to enable those skilled in the art to fully understand the present disclosure and are not intended to limit the subject matter described in the claims.

### Embodiments

In the shoplifting determination in a self-checkout register in which a customer himself/herself performs barcode scanning of a product, when the customer moves, without scanning a product, a product taken out from a product placement area where a product before scanning is placed, to a product placement area where a product after scanning is to be placed, it is determined that scanning omission has occurred. The scanning omission is corresponding to shoplifting. The scanning omission means an act of moving, without scanning the barcode of a product, a product to the product placement area where a product after scanning is to be placed. The scanning omission may be replaced with a scanning error, an unscanned product, or the like.

In this shoplifting determination, it is determined that scanning omission occurred at a stage of finishing movement of the unscanned product to the product placement area (stage at which the movement to the product placement area is completed), and a message or the like indicating that scanning omission has occurred is displayed on a display for a customer or the like to notify the customer that scanning omission has occurred.

However, when the customer is notified that the scanning omission has occurred after the unscanned product has moved to the product placement area, there is a possibility that the customer does not notice the notification. For example, the customer does not notice the notification because the customer who has moved the unscanned product to the product placement area is looking at the next product for scanning the next product. Therefore, when the customer is notified that the scanning omission of the product has occurred after the unscanned product has moved to the product placement area, the effect of preventing shoplifting cannot be sufficiently obtained.

Therefore, in the present embodiment, the presence or absence of a possibility of scanning omission before a product moves to the product placement area where a product after scanning is placed is determined. Then, when it is determined that there is a possibility that scanning omission has occurred for the product, the customer is notified that there is a possibility that scanning omission has occurred before the unscanned product moves to the product placement area. As a result, it is possible to reduce the possibility that the customer does not notice the notification, and the effect of preventing shoplifting can be sufficiently obtained.

In the following, the determination of whether there is a possibility that scanning omission has occurred for a product before the product moves to the product placement area where a product after scanning is placed may be referred to as a provisional determination. Further, the determination of whether scanning omission has occurred for a product after the product has moved to the product placement area where a product after scanning is placed may be referred to as a final determination. The final determination is a final determination at a timing at which the product is placed in the product placement area, and the determination result may be changed by an operation by staff or the like after the result of the final determination is obtained. Note that the determination of the presence or absence of scanning omission may be regarded as the determination of the presence or absence of shoplifting.

Further, the provisional determination may be referred to as a preliminary determination, a pre-determination, a primary determination, or the like. Further, the final determination may be referred to as a main determination, a secondary determination, or the like.

Further, in the following description, the term "product" may refer to an "article" different from products actually sold in stores. The "product" in the following description may be appropriately replaced with an "article" or the like.

### System Configuration

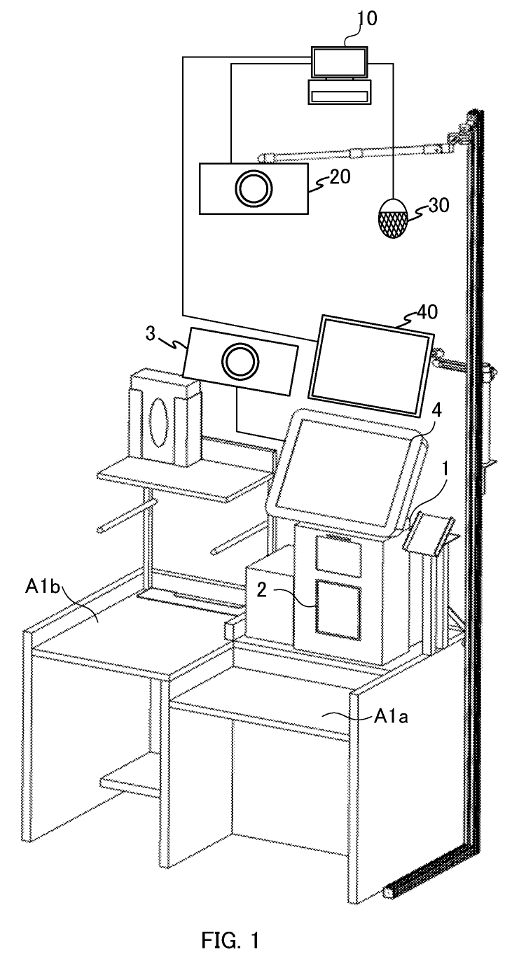

FIG. 1 is a diagram illustrating a configuration example of a self-checkout register system. As illustrated in FIG. 1, the self-checkout register system includes information processing apparatus 1, scanner 2, camera 3, and display 4. Further, FIG. 1 illustrates information processing apparatus 10, camera 20, microphone 30, and display 40 according to the present embodiment. Further to the self-checkout register system, FIG. 1 illustrates product placement tables A1a and A1b. Hereinafter, the self-checkout register system may be simply referred to as a "register" or a "point of sales (POS) register".

Product placement table A1a is a table on which the product before being scanned by scanner 2 is placed. The product before scanning placed on product placement table A1a may also include a shopping basket or a cart of the store in which the product before scanning is placed.

Product placement table A1b is a table on which the product after being scanned by scanner 2 is placed. The product after scanning placed on product placement table A1b may include a shopping basket of a customer in which the product after scanning is placed.

Information processing apparatus 1 is, for example, a computer such as a personal computer or a server. In FIG. 1, information processing apparatus 1 is placed on product placement table A1a, but may be placed in an office of the store. Information processing apparatus 1 performs, for example, checkout processing of the product.

Scanner 2 is a fixed type scanner fixed to product placement table A1a. Although not illustrated in FIG. 1, a handheld type scanner may be provided. Scanner 2 is an example of a registration apparatus used for registering the product.

Scanner 2 is connected to information processing apparatus 1. Scanner 2 scans a product code attached to the product. Scanner 2 transmits the scanned product code to information processing apparatus 1. The product code is, for example, a barcode such as a Japanese Article Number (JAN) code. Scanner 2 may be referred to as a barcode reader or a reader. An area in which the product code attached to the product is scanned by scanner 2 may be referred to as a "scanning area”. The customer scans the product code by bringing the product close to the scanning area and passing through the scanning area. The scanning of the product code attached to the product may be simply referred to as scanning of a product.

Camera 3 is connected to information processing apparatus 1. Camera 3 transmits image data of a captured image to information processing apparatus 1.

Camera 3 is installed to capture an image of the customer. Camera 3 may not be provided.

Display 4 is connected to information processing apparatus 1. Display 4 displays, for example, product information of the product scanned by a customer using scanner 2. The product information may be, for example, the name and price of the product and the number of products.

Display 4 may include a touch screen on a screen surface. The touch screen receives an operation of the customer. The customer inputs, for example, information on a product that is not attached with a product code, such as vegetables and fruits, via the touch screen and registers the product as a purchased product. For example, when the customer purchases two apples that are products that are not attached with a product code such as a barcode, the customer inputs a product name "apple" and a number of purchases "2" via the touch screen and registers the product as a purchased product. The device that receives the operation of the customer is not limited to the touch screen. The device that receives the operation of the customer may be, for example, a key input device that is separate from display 4. Alternatively, the operation of the customer may be received using a smartphone or a mobile terminal owned by the customer.

In the following, the operation of scanning the product code attached to the product and the operation of manually registering the information on the product that is not attached with the product code may be collectively referred to as "registration of product information" or "registration of product".

Further, in the following, a series of processes in the register from the start of the registration of product information to the payment of the price of the registered product by the customer is referred to as "checkout processing”. Further, the process of registering the product information is referred to as "registration processing", and the process of paying the price of the registered product is referred to as "payment processing".

Display 4 performs, for example, display corresponding to the processing state of the register. For example, the processing state of the register includes a "checkout processing standby state", a "registration processing standby state", a "registration processing state", a "payment standby state", and the like.

The checkout processing standby state indicates a state in which the register stands by for checkout processing before the customer operates the register to perform checkout. The registration processing standby state indicates a state in which the register stands by for registration of the product information by the customer while the customer is operating the register to perform checkout. The registration processing state indicates a state within a specific time from a point in time at which the registration of the product information is performed. The payment standby state indicates a state in which the registration of the information on the product that the customer attempts to purchase is completed and the register stands by for payment processing.

Examples of the transition between the processing states of the register and the display corresponding to the processing states of the register on display 4 will be described below.

Information processing apparatus 1 performs the checkout processing of the self-checkout register system. For example, information processing apparatus 1 acquires a result of the scanning of the product code by scanner 2 and operation information (e.g., input result of product information) of the customer via the touch screen on the screen surface of display 4, and performs the calculation of the total of the prices of the products registered by the customer, the payment processing for the price paid by the customer, and the like.

Information processing apparatus 1 acquires the result of the scanning of the product code by scanner 2 and the operation information (e.g., input result of product information) of the customer via the touch screen on the screen surface of display 4, and performs display control of displaying the product information of the product registered by the customer on display 4. Further, information processing apparatus 1 performs display control of displaying information corresponding to the processing state of the register on display 4 based on the operation information of the customer via the touch screen on the screen surface of display 4.

Camera 20 is installed at a position that captures images of a vicinity in which the customer scans the product with scanner 2 and that captures images of at least a part of a display region of display 4. For example, camera 20 is installed above display 4. Camera 20 is set to have an angle of view that includes the vicinity in which the customer scans the product with scanner 2 between product placement table A1a and product placement table A1b, that is, the vicinity in which the customer scans the product with scanner 2, and at least a part of the display region of display 4.

However, camera 20 may not capture an image of the vicinity in which the customer scans the product with scanner 2. In this case, camera 20 is installed at a position that captures images of at least a part of the display region of display 4.

Camera 20 is not limited to an example in which there is one camera. A plurality of cameras 20 may be installed. For example, camera 20 may be installed at each of a position that captures images of the vicinity in which the customer scans the product with scanner 2 and a position that captures images of at least a part of the display region of display 4. When camera 20 is installed at these two positions, camera 20 installed at the position that captures images of the vicinity in which the customer scans the product with scanner 2 may be referred to as object detection camera 20, and camera 20 installed at the position that images at least a part of the display region of display 4 may be referred to as feature point detection camera 20. The camera image captured by object detection camera 20 may be referred to as an object detection camera image, and the camera image captured by feature point detection camera 20 may be referred to as a feature point detection camera image.

Further, a plurality of cameras 20 may capture an image of at least a part of the display region of display 4, or a plurality of cameras 20 may capture an image of the vicinity in which the customer scans a product with scanner 2.

Information processing apparatus 10 is, for example, a computer such as a personal computer or a server. Information processing apparatus 10 may be placed in an office of the store. Information processing apparatus 10 is connected to camera 20 by wire or radio and acquires a camera image captured by camera 20. The camera image may be a still image, a plurality of temporally continuous still images, or a moving image.

Further, information processing apparatus 10 may acquire audio from microphone 30 installed around the self-checkout register system. Microphone 30 acquires sound emitted from the self-checkout register system and outputs the acquired audio to information processing apparatus 10. The sound emitted from the self-checkout register system includes, for example, sound corresponding to the processing state of the register or sound corresponding to the transition of the processing state of the register.

Information processing apparatus 10 performs, for example, determination processing for the presence or absence of a possibility of a fraudulent act (shoplifting) based on the acquired camera image and/or audio. The camera image and/or the audio are examples of a sensing result of information output from the self-checkout register system.

For example, information processing apparatus 10 performs object detection processing based on the acquired camera image. Information processing apparatus 10 determines the presence of an object and the presence or absence of the movement of the object by the object detection processing. The object detection processing may not be a method based on the camera image. Further, information processing apparatus 10 determines the processing state of the register based on the acquired camera image and/or audio. Information processing apparatus 10 determines the presence or absence of shoplifting and the like based on the result of the object detection processing and the processing state of the register.

Information processing apparatus 10 is connected to display 40 and controls the display of display 40.

Display 40 performs display based on the determination result in information processing apparatus 10 under the control of information processing apparatus 10. For example, display 40 notifies the customer of information on the fraudulent act. The notification of the information on the fraudulent act includes, for example, a notification of a message indicating that scanning omission has occurred, a notification of a message indicating that there is a possibility that scanning omission has occurred, a notification of alert message such that no scanning omission occurs, and the like. The notification of the information on the fraudulent act may be replaced with a warning on the fraudulent act. Further, the fraudulent act here may correspond to shoplifting. The shoplifting here may apply to an act of moving a product without scanning (an example of registration) the product to product placement table A1b.

In FIG. 1, an example is illustrated in which information processing apparatus 10 is provided separately from information processing apparatus 1 of the self-checkout register system, but the present disclosure is not limited to this. The processing of information processing apparatus 10 according to the present embodiment may be executed in information processing apparatus 1 of the self-checkout register system. Further, information processing apparatus 1 of the self-checkout register system may be connected to an external server by wire or radio, and a part of the processing of information processing apparatus 10 according to the present embodiment and/or the processing of information processing apparatus 1 may be executed in the external server.

Further, FIG. 1 illustrates an example in which camera 20, microphone 30, and display 40 are externally attached later to the self-checkout register system, but at least one of camera 20, microphone 30, or display 40 may be built in the self-checkout register system.

A plurality of self-checkout register systems as illustrated in FIG. 1 are present in the store. Each of the plurality of self-checkout register systems communicates with a terminal for the staff provided in the store and exchanges information.

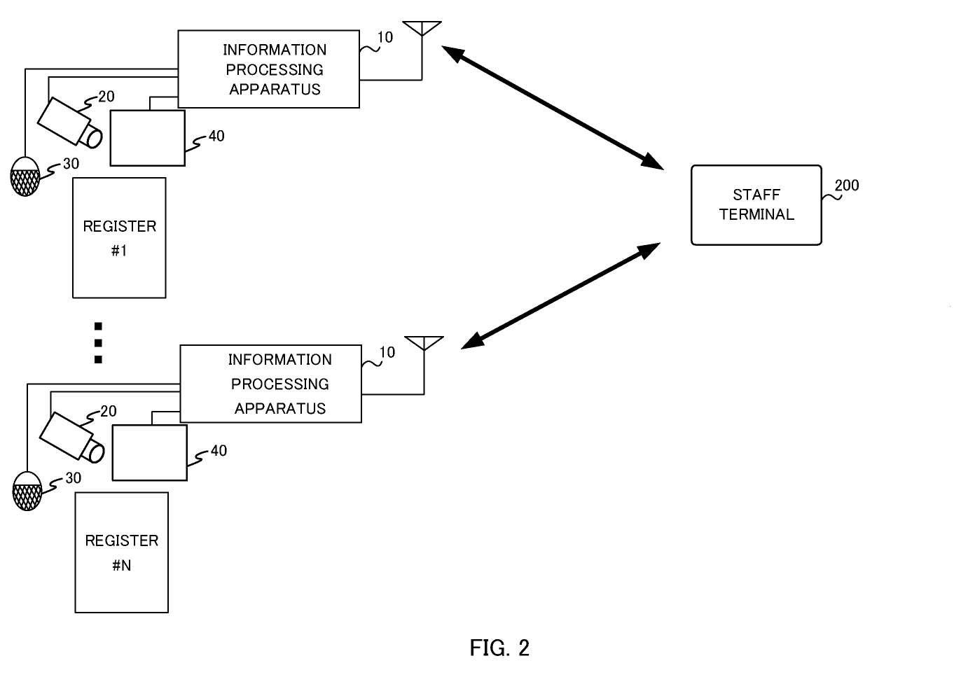

FIG. 2 is a diagram illustrating an example of a system configuration including a plurality of self-checkout register systems. FIG. 2 illustrates information processing apparatus 10 provided in each of registers #1 to #N (N is an integer of 2 or greater) and store terminal 200. Information processing apparatus 10 and store terminal 200 communicate with each other, for example, via Wi-Fi (registered trademark) or the like.

Store terminal 200 may have a form of a tablet, a smartphone, or the like, or may be a stationary information processing apparatus including a display, a keyboard, a touch screen, or the like. Store terminal 200 is used by the staff of the store to monitor the usage status of each self-checkout register system and shoplifting.

Information processing apparatus 10 transmits information such as the processing state of the register, the number of times of scanning, and the number of times of detecting scanning omission to store terminal 200. Further, information processing apparatus 10 transmits information indicating whether a person is present around each register to store terminal 200. Further, information processing apparatus 10 transmits a camera image captured by camera 20 to store terminal 200.

Store terminal 200 transmits instruction information generated based on an instruction of the staff of the store to information processing apparatus 10. The instruction information includes an instruction of a content of information to be transmitted from information processing apparatus 10 to store terminal 200, an instruction of a transmission frequency of the information to be transmitted from information processing apparatus 10 to store terminal 200, an instruction related to the setting of information processing apparatus 10, and the like. Information processing apparatus 10 generates information to be transmitted to information processing apparatus 10, sets a transmission frequency, or changes the setting of information processing apparatus 10 in accordance with the instruction information.

### Object detection processing

The object detection processing executed in information processing apparatus 10 will be described.

Information processing apparatus 10 detects (recognizes) a product included in the image of camera 20 by using, for example, a known image recognition technique (program of image recognition processing) using artificial intelligence. In other words, information processing apparatus 10 detects the product taken out from product placement table A1a by the image recognition processing. The image recognition processing of the product may be executed by another apparatus such as a server. The term "detection" refers to processing of detecting the presence of an object such as a product and specifying a position of the object, and the term "recognition" may refer to processing of identifying what item is included in the image. However, in the present embodiment, it is not necessary to accurately identify the product, and it may be difficult to accurately identify the product because the angle and range in which camera 20 can perform capturing are limited. Therefore, in the present embodiment, a description will be given with the terms "detection" and "recognition" without distinction between the terms unless distinction is necessary in particular.

### Processing State of Register

The processing state of the register determined in information processing apparatus 10 will be described. As described above, display 4 performs, for example, display corresponding to the processing state of the register. For example, the processing state of the register includes a "checkout processing standby state", a "registration processing standby state", a "registration processing state", a "payment standby state", and the like.

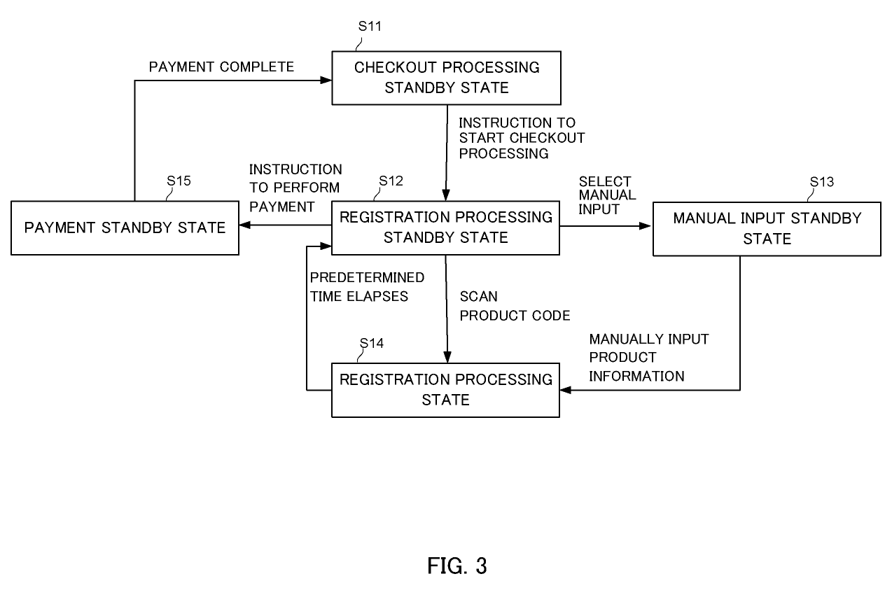

FIG. 3 is a diagram illustrating an example of the processing state of the register and a transition thereof. FIG. 3 illustrates the processing states of the five registers and examples of the transitions between the states.

The checkout processing standby state (S11 in FIG. 3) is a state in which the register stands by for the checkout processing before the customer operates the register to perform checkout. For example, in the checkout processing standby state, when the customer issues an instruction to start checkout via the touch screen of display 4 to perform checkout, the processing state of the register transitions from the checkout processing standby state to the registration processing standby state (S12 in FIG. 3).

In the registration processing standby state, when the customer scans the product code of a certain product, the processing state of the register transitions from the registration processing standby state to the registration processing state (S14 in FIG. 3). In the registration processing state, after a certain time elapses, the processing state of the register transitions from the registration processing state to the registration processing standby state.

In the registration processing standby state, when the customer issues an instruction to perform manual input to register a product that is not attached with a product code to the register via the touch screen of display 4, the processing state of the register transitions from the registration processing standby state to a manual input standby state (S13 in FIG. 3).

The manual input standby state indicates a state in which the register stands by for manual input of the product information by the customer while the customer is operating the register to perform checkout.

In the manual input standby state, when the customer manually inputs the information on the product that is not attached with the product code, the processing state of the register transitions from the manual input standby state to the registration processing state. In the registration processing state, after a certain time elapses, the processing state of the register transitions from the registration processing state to the registration processing standby state.

In the registration processing standby state, when the customer issues an instruction to pay the price of the product via the touch screen of display 4, the processing state of the register transitions from the registration processing standby state to the payment standby state (S15 in FIG. 3).

In the payment standby state, when the customer completes the payment of the price of the product, the processing state of the register transitions from the payment standby state to the checkout processing standby state.

The registration processing standby state, the registration processing state, and the manual input standby state may be collectively referred to as an in the middle of registration state. In other words, the in the middle of registration state is a state in which the processing state of the register is neither the payment standby state nor the checkout processing standby state.

In the present embodiment, information processing apparatus 10 determines the processing state of the register as illustrated in FIG. 3 based on the acquired camera image and/or audio. For example, in the present embodiment, information processing apparatus 10 detects a feature point of an image from the camera image resulting from capturing an image of the display region of display 4, thereby determining the processing state of the register corresponding to the display of display 4.

Information processing apparatus 10 may acquire information on the processing state of the register from the self-checkout register system instead of determining the processing state of the register as illustrated in FIG. 3 based on the acquired camera image and/or audio. When the information on the processing state of the register is acquired from the self-checkout register system, information processing apparatus 10 may not determine the processing state of the register based on the acquired camera image and/or audio.

Hereinafter, a display example of display 4 corresponding to the processing state of the register will be described. The display examples illustrated below are examples, and the present disclosure is not limited to the following display examples. Further, in the following, a correspondence relationship between the display examples of display 4 and the processing states of the register illustrated in FIG. 3 will be described, but the correspondence relationship illustrated below is an example, and the present disclosure is not limited to this. For example, the correspondence relationship between the display examples of display 4 and the processing states of the register may be different depending on the self-checkout register system. For example, even in a case where the display examples of display 4 are common, the processing states of the register corresponding to the display examples may be different depending on the self-checkout register system. The correspondence relationship between the display examples of display 4 and the processing states of the register may be stored in information processing apparatus 10 in advance. Further, when the display examples are changed due to the update of the self-checkout register system, the correspondence relationship stored in information processing apparatus 10 may also be updated.

### Display Example 1 of Display Corresponding to Processing State of Register

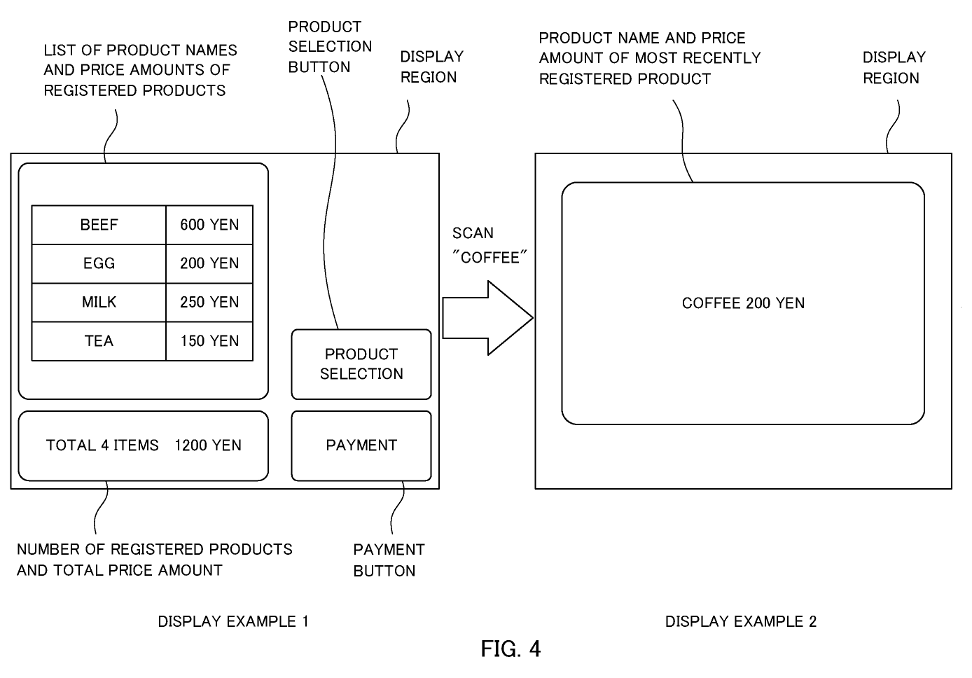

FIG. 4 is a diagram illustrating Example 1 of a transition of display of display 4. FIG. 4 illustrates Display Example 1 and Display Example 2 that transitions from Display Example 1. The transition of the display example illustrated in FIG. 4 corresponds to an example of the transition from the registration processing standby state to the registration processing state in FIG. 3.

Display Example 1 is a display example corresponding to the registration processing standby state. The display region illustrated in Display Example 1 includes a region in which a list of product names and the price amounts of the registered products is displayed, a region in which the number of items and the total amount of the registered products are displayed, a region corresponding to a "payment button", and a region corresponding to a "product selection button".

In the region in which the list of the product names and the price amounts of the registered products is displayed, the product names of the registered products and the price amounts corresponding to the product names are displayed in a list. In the example of FIG. 4, "beef", "egg", "milk", and "tea" are the registered products, and the product names and the price amounts of the respective registered products are displayed in association with each other.

In the region in which the number of items and the total amount of the registered products are displayed, the number of items and the total amount of the registered products are displayed. In the example of FIG. 4, it is displayed that four products are registered and the total amount of the four products is 1200 yen.

When the region corresponding to the "payment button" is pressed by the customer, the registration processing is completed, and the display transitions to the payment processing.

When the region corresponding to the "product selection button" is pressed by the customer, the display transitions to a screen for registering a product that is not attached with a product code.

When the customer scans the product code of "coffee" in a state in which Display Example 1 is displayed, the display transitions from Display Example 1 to Display Example 2. When the customer scans the product code of "coffee" in a state in which Display Example 1 is displayed, a scanning sound may be emitted from a speaker of the register.

Display Example 2 is a display example indicating the registration processing state. The display region illustrated in Display Example 2 includes a region in which the product name and the price amount of the product registered most recently are displayed. Display Example 2 is an example in which the fact that the operation of scanning the product code attached to the product (in the example of FIG. 4, "coffee") is performed is displayed, and indicates the product recognized by the operation of scanning the product code.

In the region in which the product name and the price amount of the product registered most recently are displayed, the product name and the amount of the product registered most recently are displayed. In the example of FIG. 4, since "coffee" is most recently scanned, "coffee" as the product name and "200 yen" as the price amount thereof are displayed.

When a certain time elapses after Display Example 2 is displayed, the display corresponding to the same registration processing standby state as Display Example 1 is displayed.

For example, information processing apparatus 10 detects a feature point of the camera image and determines, in a distinguished manner, whether the display of display 4 is the display corresponding to the registration processing state as in Display Example 1 and whether the display of display 4 is the registration processing state as in Display Example 2 based on the feature point. For example, a feature point for distinguishing whether four regions are arranged in the display region as in Display Example 1 or whether one region is present in the display region as in Display Example 2 may be detected. Further, for example, a feature point for specifying whether the "payment button" is present in the display region may be detected. In the example of FIG. 4, information processing apparatus 10 detects a feature point that can distinguish a difference between Display Example 1 and Display Example 2.

When the transition from the registration processing standby state as in Display Example 1 to the registration processing state as in Display Example 2 is detected, information processing apparatus 10 determines that the scanning has been normally performed.

When detecting the scanning sound, information processing apparatus 10 may determine that the processing state of the register transitions from the registration processing standby state to the registration processing state and that the scanning has been normally performed.

When the product that requires age verification is scanned instead of the display as in Display Example 2, a display region for age verification and a display region corresponding to an age verification button of "Yes" and "No" are displayed as a display indicating that purchase of the product is restricted. Information processing apparatus 10 may detect a feature point of the camera image and determine that the display of display 4 is the display for age verification corresponding to the registration processing state based on the feature point.

The detection that the processing state of the register is the registration processing state, that is, that the scanning has been normally performed may be performed by combining the detection of the display of display 4 corresponding to the registration processing state, the detection of the scanning sound, and the like as described above. For example, the scanning may be detected as being normally performed only when the display of display 4 corresponding to the registration state is detected and the scanning sound is detected. In other words, when at least one of the display of display 4 corresponding to the registration state and the scanning sound is not detected, it may be detected that the scanning has not been normally performed. In this way, even in an environment in which display of display 4 of another register or even scan sound of another register is likely to be detected as being normally performed, such as a case in which another register is close by, it is possible to accurately detect that the scanning has been normally performed. Further, when at least one of the display of display 4 corresponding to the registration state and the scanning sound is detected, it may be detected that the scanning has been normally performed. In this way, for example, even when display 4 is likely to be shielded due to congestion or when it is difficult to detect the scanning sound due to surrounding noise, it is possible to accurately detect that the scanning has been normally performed. Since the environment in which it is possible to accurately detect that the scanning has been normally performed by combining the detection is different, the staff or the like may change what combination is used, according to the situation.

When the information on a product that is not attached with a product code is manually input to the self-checkout by the customer instead of the registration of the product by scanning of a barcode, the processing state of the register transitions to the manual input standby state. In this case, the detection that the processing state of the register is the manual input standby state may correspond to the detection that at least one of an image feature point of "displaying a list of product names of products that are not attached with product codes" or an image feature point of "displaying a screen for inputting the number of items" is present on display 4. Note that either "displaying a list of product names of products that are not attached with product codes" or "displaying a screen for inputting the number of items" may be selectable as the detection target.

### Display Example 2 of Display Corresponding to Processing State of Register

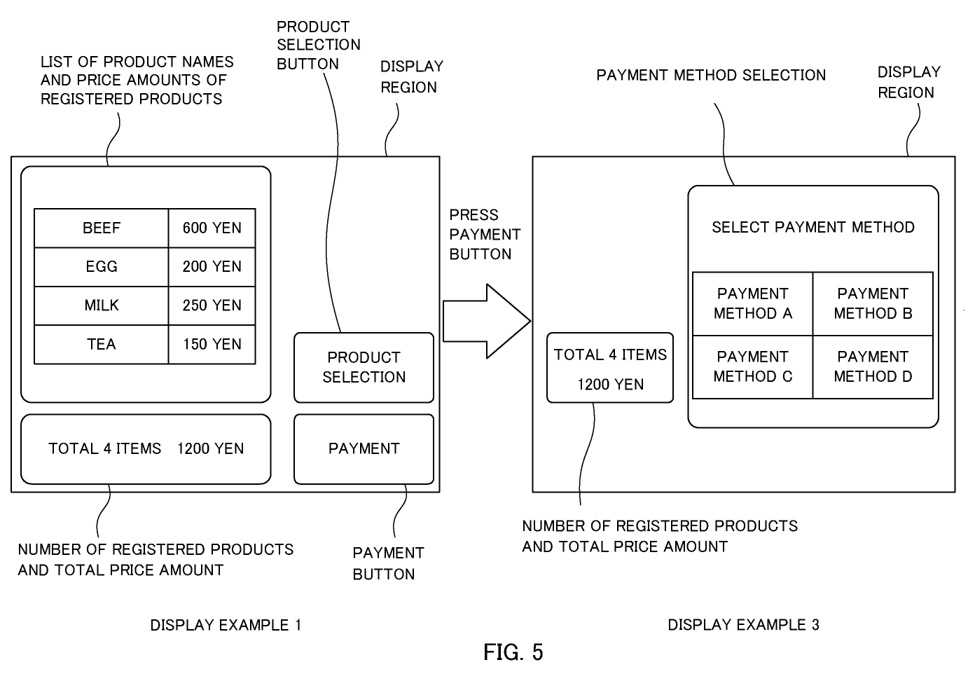

FIG. 5 is a diagram illustrating Example 2 of the transition of the display of display 4. FIG. 5 illustrates Display Example 1 and Display Example 3 that transitions from Display Example 1. The transition of the display example illustrated in FIG. 5 corresponds to an example of the transition from the registration processing standby state to the payment standby state in FIG. 3. Display Example 1 of FIG. 5 is the same as Display Example 1 of FIG. 4, and thus the description thereof will be omitted.

When the customer presses the region corresponding to the "payment button" to start the payment of the price of the registered product after the registration of the product to be purchased is completed, the display of display 4 transitions from Display Example 1 to Display Example 3.

Display Example 3 is a display example corresponding to the payment standby state. The display region illustrated in Display Example 3 includes a region in which a button for selecting a payment method is displayed and a region in which the number of items and the total amount of the registered product are displayed.

When detecting the transition from the registration processing state as in Display Example 1 to the payment standby state as in Display Example 3, information processing apparatus 10 determines that it stands by for payment of the customer.

### Display Example 3 of Display Corresponding to Processing State of Register

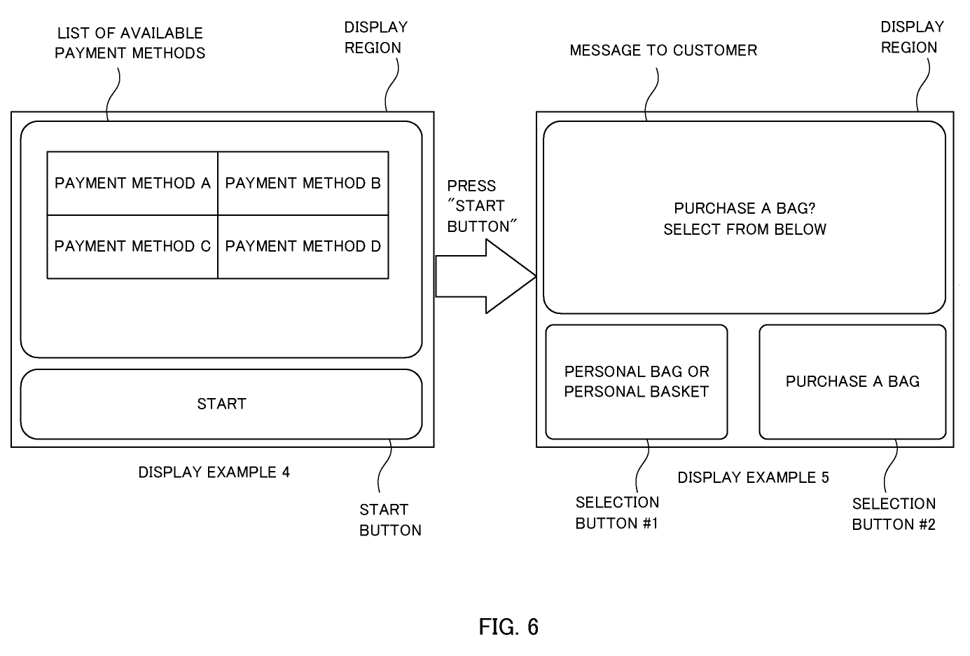

FIG. 6 is a diagram illustrating Example 3 of the transition of the display of display 4. FIG. 6 illustrates Display Example 4 and Display Example 5 that transitions from Display Example 4.

Display Example 4 is a display example indicating the checkout processing standby state (S11 in FIG. 3). The display region illustrated in Display Example 4 includes a region in which a list of available payment methods is displayed and a region corresponding to a "start button" that is pressed in a case of starting the checkout processing.

When the customer presses the region corresponding to the "start button" to start the checkout processing, the display of display 4 transitions from Display Example 4 to Display Example 5.

Display Example 5 is a display for selecting whether to purchase a bag (e.g., plastic bag) for carrying the product to be purchased by the customer. Display Example 5 is a display example indicating the checkout processing standby state (S11 in FIG. 3).

When the customer presses any of selection button #1 or selection button #2 to input the information on whether to purchase a bag, the display of display 4 transitions from Display Example 5 to another display.

When detecting the checkout processing standby state as in Display Example 4 or Display Example 5, information processing apparatus 10 determines that it stands by for the start of the checkout processing (start of scanning) of the customer.

### Provisional Determination and Final Determination in Present Embodiment

As described above, in the determination of the presence or absence of shoplifting (presence or absence of scanning omission) or the like based on a result of the object detection processing and the processing state of the register, information processing apparatus 10 performs two determinations, namely, the provisional determination and the final determination.

In the provisional determination, information processing apparatus 10 determines whether there is a possibility of scanning omission before the movement of the product that has passed through the vicinity of scanner 2 to product placement table A1b by the customer is completed. For example, when the product that has passed through the vicinity of scanner 2 is normally scanned, information processing apparatus 10 determines that there is no possibility of scanning omission, and when the product that has passed through the vicinity of scanner 2 is not normally scanned, information processing apparatus 10 determines that there is a possibility of scanning omission.

When it is determined by the provisional determination that there is a possibility of scanning omission, display 40 displays information indicating that there is a possibility of scanning omission. The display of display 40 when it is determined by the provisional determination that there is a possibility of scanning omission may be referred to as "display of provisional determination" below.

In the final determination, information processing apparatus 10 determines whether scanning omission has occurred in a case where the movement of the product that has passed through the vicinity of scanner 2 to product placement table A1b by the customer is completed. For example, when the product that has passed through the vicinity of scanner 2 is normally scanned, information processing apparatus 10 determines that no scanning omission has occurred, and when the product that has passed through the vicinity of scanner 2 is not normally scanned, information processing apparatus 10 determines that scanning omission has occurred.

When it is determined by the final determination that scanning omission has occurred, display 4 displays information indicating that scanning omission has occurred. The display of display 40 when it is determined by the final determination that scanning omission has occurred may be referred to as "display of final determination" hereinafter.

The display of the provisional determination on display 40 and the display of the final determination are different from each other. For example, the display of the provisional determination may be a display that softens the impression on the customer as compared with the display of the final determination. The display example on display 40 will be described, hereinafter.

When it is determined by the provisional determination that there is a possibility of scanning omission, information processing apparatus 10 may not transmit the result of the provisional determination to store terminal 200. When information processing apparatus 10 does not transmit the result of the provisional determination to store terminal 200, the result of the provisional determination is not displayed on store terminal 200. As a result, presenting excessive information to the staff who operates store terminal 200 can be avoided, so that the burden on the staff can be reduced.

Here, in the provisional determination and the final determination, it is detected whether the movement of the product to product placement table A1b has been completed. This detection is executed in the object detection processing described above. In the object detection processing, the area is set for the camera image resulting from capturing an image of the register and the vicinity of the register.

Hereinafter, an example of the setting of the area in a camera image will be described.

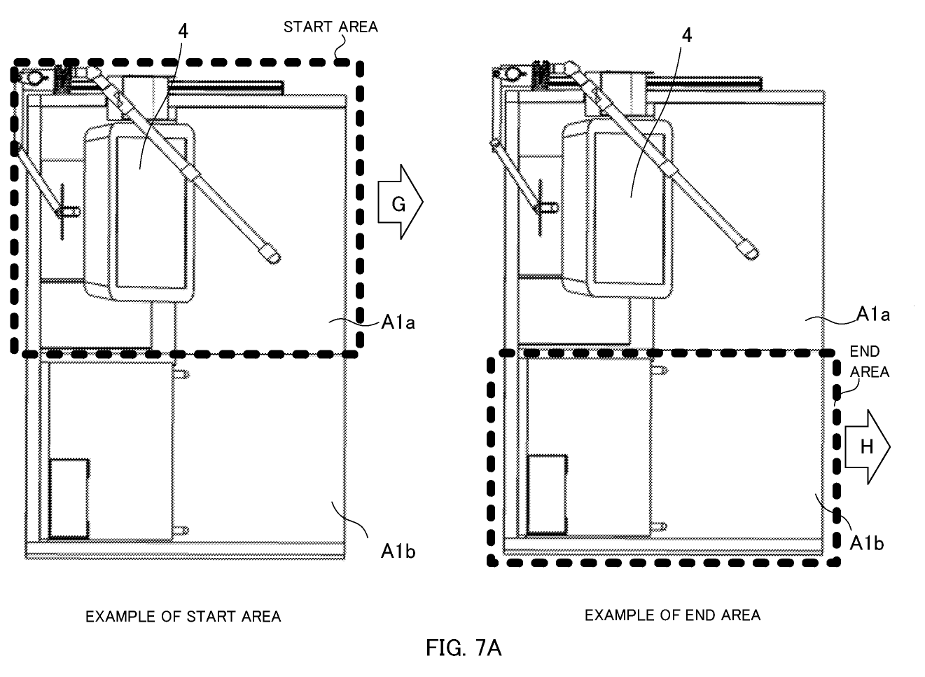

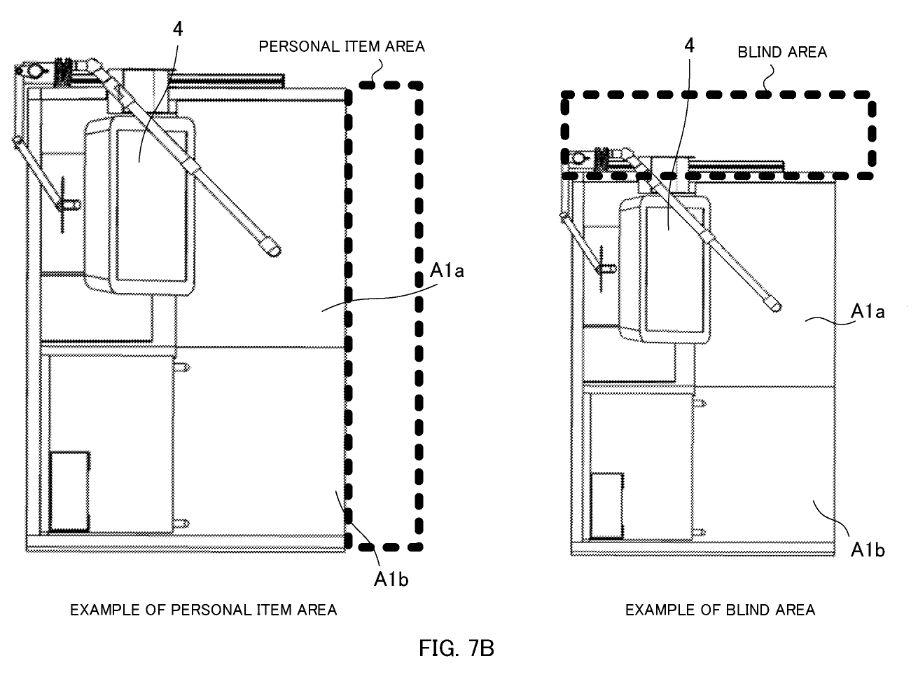

FIGS. 7A and 7B are diagrams illustrating an example of the area setting. FIG. 7A illustrates a capturing range in which camera 20 captures an image of the self-checkout register system illustrated in FIG. 1 from above, an example of a start area set in the capturing range, and an example of an end area. Further, FIG. 7B illustrates a capturing range in which camera 20 captures an image of the self-checkout register system illustrated in FIG. 1 from above, an example of a personal item area set in the capturing range, and an example of a blind area.

The start area is an area in which it is assumed that a product before scanning and a shopping cart containing a product before scanning are placed. The start area corresponds to an area in which the movement of the product before scanning is started. The start area includes at least a range of product placement table A1a. The start area is set within the range of the register including product placement table A1a, but may include a margin with respect to the range of the register. A range wider than product placement table A1a may be included in the start area. For example, in addition to the range of product placement table A1a, a range in which the range of product placement table A1a is extended to the customer side (e.g., in the direction of arrow G in FIG. 7A) may be included in the start area. Further, a part of product placement table A1b may be included in the start area.

When the customer holds the product present in the start area by hand, it may be determined that the movement of the product has started. Alternatively, when the position and the size of the product present in the start area are changed in the camera image, it may be determined that the movement of the product has started.

The end area is an area in which it is assumed that a bag, a personal bag, a personal basket, or the like in which the product after scanning is stored is placed. The end area corresponds to an area in which the movement of the product is ended. The end area includes at least a range of product placement table A1b. The end area is set within the range of the register including product placement table A1b, but may include a margin with respect to the range of the register. A range wider than product placement table A1b may be included in the end area. For example, in addition to the range of product placement table A1b, a range in which the range of product placement table A1b is extended to the customer side (e.g., in the direction of arrow H in FIG. 7B) may be included in the start area. Further, a part of product placement table A1a may be included in the end area.

When the product held by the hand of the customer is moved to the end area and the position and the size of the product do not change in the camera image, it may be determined that the movement of the product to the end area has been completed. Alternatively, when it is detected that the product held in the hand is moved to the end area and the hand is separated from the product, it may be determined that the movement of the product to the end area has been completed.

The personal item area is an area in which it is assumed that an image of a person who operates the register while holding a personal item (e.g., a customer) is captured and/or an area in which it is assumed that a personal item of the customer is placed. The personal item area is set outside the range of the register in the camera image. The personal item area corresponds to an area in which a personal item (e.g., a customer’s wallet, smartphone, or the like) that may be erroneously recognized as a product appears first. The personal item area may not be set. However, the range of the register in the camera image may be included in the personal item area. For example, a part or all of the end area described above may be included in the personal item area. Further, a part of the start area described above may be included in the personal item area. The personal item area may overlap the start area or the end area. Here, when the personal item area and the start area or the end area overlap each other, which area to be prioritized may be optionally settable. For example, in this case, the personal item area may be prioritized.

The blind area is an area in which it is not assumed that an image of a person who operates the register while holding a personal item (e.g., a customer) is captured and/or an area in which it is not assumed that a personal item of the customer is placed. The blind area is set outside the range of the register in the camera image. In the blind area, an image of the adjacent register is captured or an image of the customer or the staff of the store moving around is captured, so that the blind area corresponds to an area that can be noise. An image of an item, a person, or the like captured in the blind area is excluded from the target of the image processing such as product detection. The blind area may not be set.

Each area may be manually set for the camera image when camera 20 is installed in the register, the angle of view of camera 20 is set, and the camera image is obtained.

Although not illustrated in FIGS. 7A and 7B, an area in which scanning is performed by scanner 2 may be set as the scanning area.

Examples of the provisional determination and the final determination when the areas are set as described above will be described.

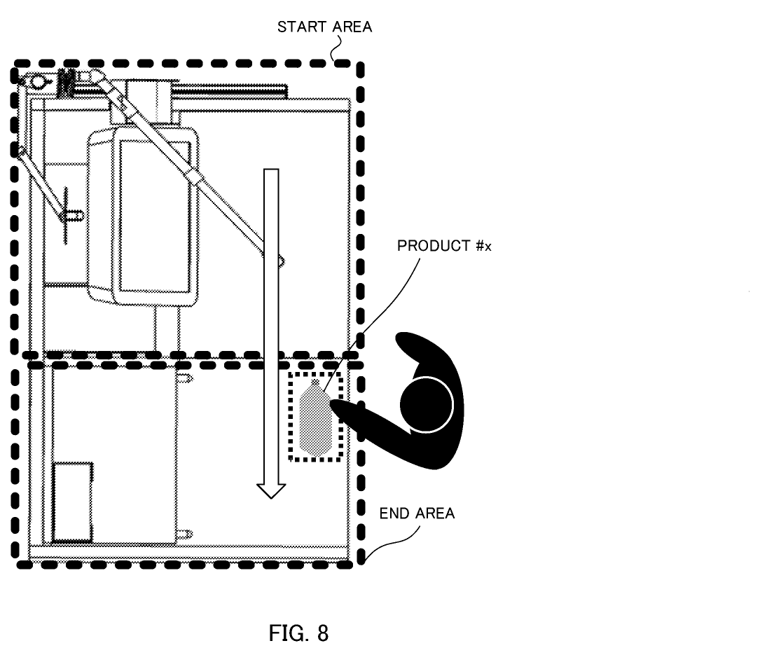

FIG. 8 is a diagram illustrating an example of the provisional determination and the final determination. FIG. 8 illustrates an example in which a customer moves a product in the self-checkout register system illustrated in FIG. 1.

Information processing apparatus 10 detects the product (hereinafter, product #x) that has started moving from the start area. For example, information processing apparatus 10 detects the product in the start area held by the customer as the product that has started moving from the start area. Hereinafter, the product that has started moving from the start area may be referred to as product #x.

In the camera image, a frame may be superimposed on the image in a range of product #x as illustrated in FIG. 8.

When detecting that product #x has moved from the start area to the end area and detecting that product #x has not been scanned, information processing apparatus 10 performs the provisional determination that there is a possibility of scanning omission of product #x. In this stage of the provisional determination, the movement of product #x to the end area is not completed. For example, as illustrated in FIG. 8, product #x is in the process of being moved in the end area. Information processing apparatus 10 determines that product #x is in the process of being moved when product #x is detected from the end area and completion of movement is not detected, for example. When the entire range of product #x is present in the end area, information processing apparatus 10 may detect that product #x has moved to the end area, and when at least a part of the range of product #x is present in the end area or when half or more of the range of product #x is present in the end area, information processing apparatus 10 may detect that product #x has moved to the end area.

Further, when detecting that the movement of unscanned product #x to the end area has been completed, information processing apparatus 10 performs the final determination that scanning omission of product #x has occurred. In this stage of the final determination, the movement of product #x to the end area is completed. For example, the detection of the completion of the movement of product #x to the end area corresponds to the detection that product #x is stationary in the end area or the detection that the hand of the customer is separated from product #x in the end area.

The time series of the provisional determination and the final determination described above will be described.

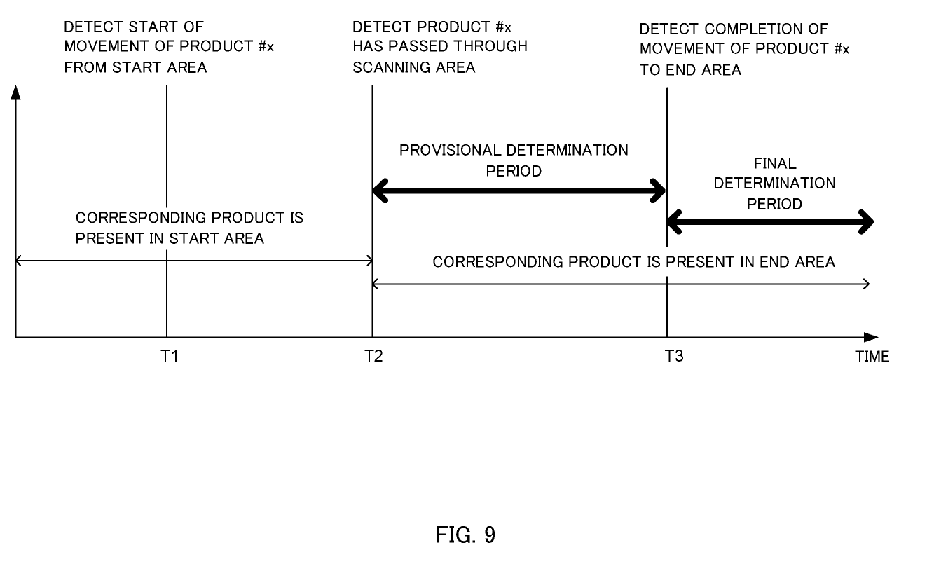

FIG. 9 is a diagram illustrating an example of a flow of the provisional determination and the final determination. FIG. 9 illustrates an example of a relationship between time and the movement of the product. The horizontal axis in FIG. 9 represents the time axis. In the example illustrated in FIG. 9, product #x is stationary in the start area at a time before a point in time T1.

At the point in time T1, it is detected that product #x has started moving from the start area (e.g., product placement table A1a). At the point in time T2, it is detected that product #x has passed through the scanning area set in the vicinity of scanner 2. At the point in time T3, it is detected that product #x is placed in the end area (e.g., product placement table A1b). In this case, the provisional determination is executed in a time between the point in time T2 and the point in time T3. Further, the final determination is executed at the point in time T3 or later. When it is not detected that product #x has been scanned, the provisional determination that there is a possibility that scanning omission of product #x has occurred is performed at the time of the provisional determination. When it is not detected that product #x has been scanned, the final determination that scanning omission of product #x has occurred is performed at the time of the final determination.

As described above, in the provisional determination that there is a possibility that scanning omission of product #x has occurred and the final determination that scanning omission of product #x has occurred, information to be notified to the customer is made different. Hereinafter, display examples in each of a provisional determination result and a final determination result will be illustrated. The display in the provisional determination result that there is a possibility that scanning omission of the product has occurred is simply described as the display of the provisional determination or the display at the time of the provisional determination, and the display in the final determination result that scanning omission of the product has occurred is simply described as the display of the final determination or the display at the time of the final determination. When the determination result is notified by a method other than the display of the determination result on the display or the like, the term "display" may be replaced with another term such as "notification" or "presentation”. The provisional determination result that there is no possibility that scanning omission of the product has occurred and the final determination result that scanning omission of the product has not occurred may not be the target of the notification to the customer or the like.

### Display Examples of Provisional Determination and Final Determination

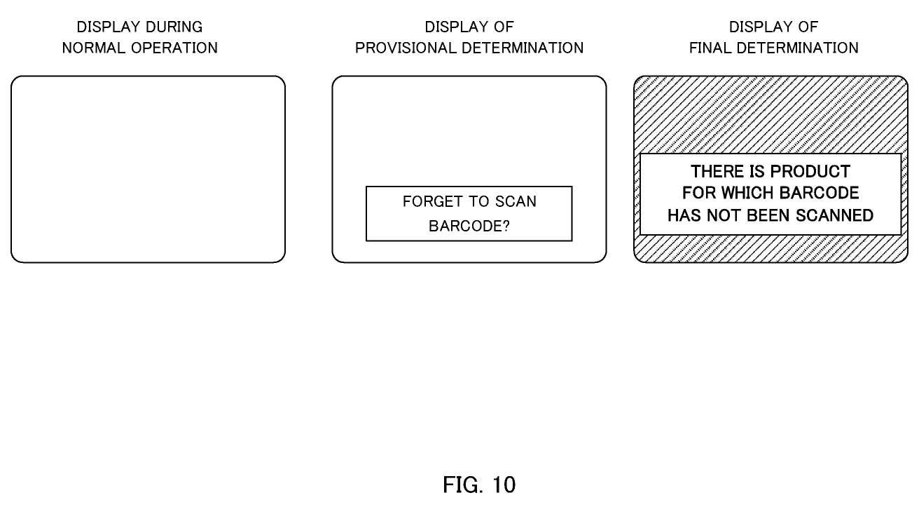

FIG. 10 is a diagram illustrating display examples on display 40. FIG. 10 illustrates display examples of display 40 respectively in the display during normal operation, the display of the provisional determination, and the display of the final determination.

During normal operation, a message or the like may not be displayed on display 40. Here, the normal operation corresponds to a case in which the provisional determination that there is a possibility that scanning omission of product #x has occurred is not performed or the final determination that scanning omission of product #x has occurred is not performed.

The display of the provisional determination, that is, the display when the provisional determination that there is a possibility that scanning omission of product #x has occurred is performed includes a message for notifying the customer that there is a possibility that scanning omission has occurred.

The display of the final determination, that is, the display when the final determination that scanning omission of product #x has occurred is performed includes a message for notifying the customer that scanning omission has occurred.

The message in the display of the provisional determination is different from the message in the display of the final determination. For example, the message in the display of the final determination is displayed in an emphasized manner as compared with the message in the display of the provisional determination. For example, at least one aspect of the size of the characters, the size of the region in which the message is displayed, the color of the characters, the brightness of the display, or the like is different between the message in the display of the provisional determination and the message in the display of the final determination. Further, the position of the region in which the message is displayed in the display region of display 40 may be different between the display of the provisional determination and the display of the final determination. Further, the content of the message may be different between the display of the provisional determination and the display of the final determination. For example, the message in the display of the provisional determination may be a soft content that does not give a strong impression to the customer as compared with the message in the display of the final determination.

Although the display of display 40 in the provisional determination and the final determination has been described, the method of presenting the information to the customer is not limited to the display on display 40. For example, information on at least one of the result of the provisional determination and the result of the final determination may be presented by another means such as audio or a warning light. Even when a means different from the display is used, the method of presenting the information may be different between the result of the provisional determination and the result of the final determination.

For example, the notification to the customer by the sound output from the speaker (not illustrated in the drawing) may be different between the provisional determination and the final determination. For example, the sound output from the speaker at the time of the provisional determination may be smaller than the sound at the time of the final determination. Alternatively, when the audio message is output from the speaker, different audio messages may be output between the time of the final determination and the time of the provisional determination. Alternatively, the notification to the customer by the sound output from the speaker may be performed only at the time of the final determination and not performed at the time of the provisional determination.

However, when the notification of shoplifting is performed a predetermined number of times or more during the single checkout processing at this time, the same message or sound as that at the time of the final determination may be notified to the customer at the time of the provisional determination. Alternatively, when the notification of shoplifting is performed a predetermined number of times or more during the past checkout processing performed once or more before the present checkout process, the same message or sound as that at the time of the final determination may be notified to the customer at the time of the provisional determination. Here, the notification of shoplifting may include both or any one of the notification at the time of the provisional determination and the notification at the time of the final determination. Further, processing of specifying whether the person who is performing the present checkout processing is the same as the person who has performed the past checkout processing may be executed by the existing image processing (e.g., processing using AI technology) based on an image resulting from capturing an image of the person. In this way, for example, when the customer is a habitual shoplifter, it is made possible to further increase the effect of preventing shoplifting.

Here, the notification at the time of the provisional determination may be performed on the customer who is the determination target and may not be performed on the staff. The notification at the time of the final determination may be performed on the staff without the notification at the time of the provisional determination. Since the notification at the time of the provisional determination is generated even when no shoplifting actually occurs, when the provisional determination is notified to the staff, there is a possibility that the amount of the notification information is large when the number of self-checkout register systems is large. However, notifying the staff of the time of the final determination without the notification at the time of the provisional determination makes it possible to suppress the increase in the notification information.

The information to be notified to the staff may be changed between the time of the provisional determination and the time of the final determination. For example, at the time of the provisional determination, the staff may be notified that the corresponding product has passed through the scanning area without passing through the barcode, and at the time of the final determination, in addition to the final determination result that the corresponding product has passed through the scanning area without passing through the barcode and the movement of the corresponding product to the final area is completed, the staff may be notified of information such as the image of the corresponding product. As a result, at the time of the provisional determination, the amount of information to be notified can be suppressed, and at the time of the final determination, the staff can be appropriately notified of which product has scanning omission or the like.

### Withdrawal of Provisional Determination

The provisional determination that there is a possibility that scanning omission has occurred may be withdrawn by detecting a specific operation of the customer after the provisional determination. For example, when a specific operation of the customer is detected, information processing apparatus 10 may withdraw the provisional determination that there is a possibility that scanning omission has occurred. Hereinafter, three operations that are the target of the withdrawal will be described as examples, but the operation that is the target of the withdrawal is not limited to these in the present disclosure.

### Example 1 of Specific Operation:

When the movement of the corresponding product to product placement table A1b is detected after the provisional determination that there is a possibility that scanning omission has occurred, the provisional determination is withdrawn, and the final determination that scanning omission has occurred is performed. In this case, the display of the provisional determination transitions to the display of the final determination.

### Example 2 of Specific Operation:

When an operation that is assumed to be re-scanning of the corresponding product is detected after the provisional determination that there is a possibility that scanning omission has occurred, the provisional determination is withdrawn, and the display transitions from the display of the provisional determination to the display during normal operation. Here, the operation that is assumed to be re-scanning of the corresponding product is, for example, an operation of moving the corresponding product to the scanning area in the vicinity of scanner 2 or an operation of returning the corresponding product to the start area.

### Example 3 of Specific Operation:

When the movement of the corresponding product to product placement table A1b is not detected after the provisional determination that there is a possibility that scanning omission has occurred, the provisional determination is withdrawn, and the display transitions from the display of the provisional determination to the display during normal operation. The case in which the movement of the corresponding product to product placement table A1b is not detected corresponds to a case in which the movement of a predetermined distance or more is detected within a predetermined time or a case in which the movement of the product is not detected within the predetermined time. Here, the case in which the movement of the corresponding product to product placement table A1b is not detected corresponds to a case in which the item detected as the corresponding product is a personal item or the like. In a case of the personal item, the customer stores the personal item in his or her own bag carried by the customer, so that the personal item is not placed on product placement table A1b. Further, another example of the case in which the movement of the corresponding product to product placement table A1b is not detected corresponds to a case in which the condition for detecting the movement of the corresponding product to product placement table A1b is not satisfied. Here, examples of the case in which it is determined that the condition for detecting the movement is not satisfied include a case in which the detection of the corresponding product itself has not been possible continuously for a predetermined time during the movement of the corresponding product and a case in which a distance difference between a position at which the corresponding product is detected at a certain point in time and a position at which the corresponding product is detected at a point in time that is one or more points earlier than the certain point in time is larger than a predetermined value. In these cases, there is a high possibility that an error has occurred in detection of the movement and the result of the provisional determination that there is a possibility that scanning omission has occurred is not reliable, so that the provisional determination is withdrawn.

Example 3 of the specific operation may also correspond to a case in which the shoplifting of directly moving the product that is not a personal item to the bag is performed and a case in which the product is intentionally hidden to make it undetectable. Therefore, whether to set this operation to be considered as the condition for withdrawing the provisional determination may be changed by the instruction of staff.

Even when the customer moves the product through the scanning area without scanning the product, the display of the provisional determination is not performed on display 40 after the processing state of the register is detected as the payment standby state (see FIGS. 3 and 5). For example, even when the customer moves the product through the scanning area without scanning the product, the provisional determination that there is a possibility that scanning omission has occurred is not performed after the payment standby state is detected. Alternatively, when the customer moves the product through the scanning area without scanning the product, the provisional determination that there is a possibility that scanning omission has occurred is performed, but the display of the provisional determination is not performed after the payment standby state is detected. This is because, when the processing state of the register is the payment standby state, the customer has a high possibility of having already completed the movement of all the products, and the item on which the provisional determination is performed is likely to be a personal item or the like rather than the product.

When the processing state of the register is detected as the payment standby state, the provisional determination and the final determination may not be performed in the first place. Alternatively, the provisional determination and/or the final determination may be performed, but the result may not be notified to the customer. Specifically, when the processing state of the register is detected as the payment standby state, information processing apparatus 10 may stop the object detection processing, may execute the object detection processing but stop the processing of the provisional determination and the final determination, or may execute the processing of the provisional determination and the final determination but stop the control of the display of display 40. Information processing apparatus 10 may select any of the stop of the object detection processing, the stop of the processing of the provisional determination and the final determination, and the stop of the control of the display. This selection is performed at the time of the initial setting before the actual operation is started.

When the processing state of the register is the payment standby state, the register is in a state in which registering a product cannot be performed. Therefore, regardless of whether the provisional determination is performed and regardless of the result of the provisional determination, the product cannot be registered even when the product is scanned. In such a state, notifying the customer of the result of the provisional determination causes confusion to the customer, so that information processing apparatus 10 may perform the operation of withdrawing the provisional determination or not displaying the result of the provisional determination from the viewpoint of avoiding the confusion.

Further, even when the customer moves a product through the scanning area without scanning the product, the display of the provisional determination is not performed on display 40 when the processing state of the register is detected as the checkout processing standby state (see FIGS. 3 and 6). For example, even when the customer moves a product through the scanning area without scanning the product, the provisional determination that there is a possibility that scanning omission has occurred is not performed when the checkout processing standby state is detected. Alternatively, when the customer moves a product through the scanning area without scanning the product, the provisional determination that there is a possibility that scanning omission has occurred is performed, but the display of the provisional determination is not performed when the checkout processing standby state is detected.

When the processing state of the register is detected as the checkout processing standby state, information processing apparatus 10 may stop the object detection processing, may execute the object detection processing but stop the processing of the provisional determination and the final determination, or may execute the processing of the provisional determination and the final determination but stop the control of the display of display 40. Information processing apparatus 10 may select any of the stop of the object detection processing, the stop of the processing of the provisional determination and the final determination, and the stop of the control of the display.

Here, the transition of the display when the provisional determination is withdrawn will be described.

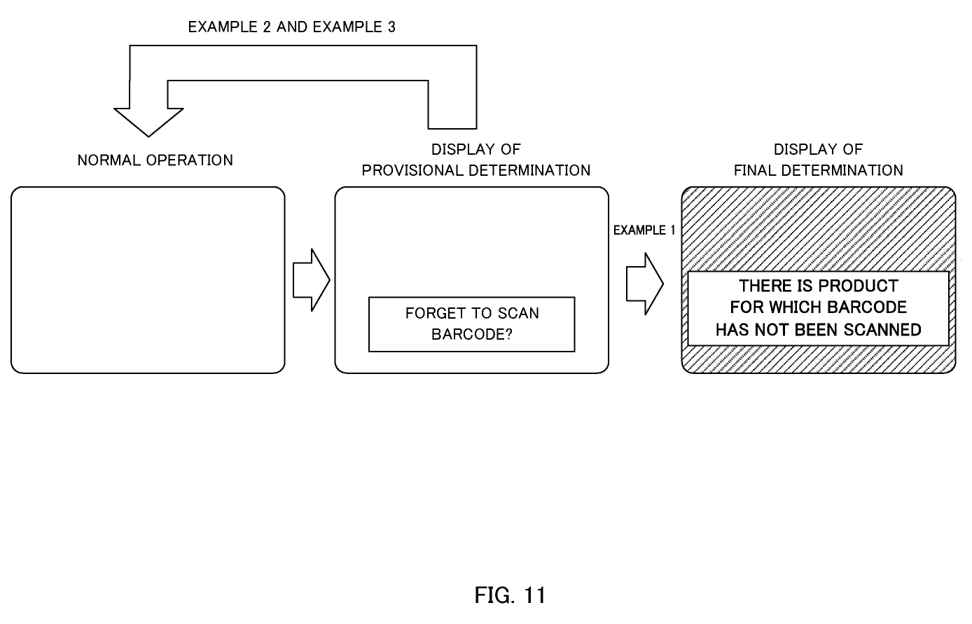

FIG. 11 is a diagram illustrating an example of the transition from the display of the provisional determination. FIG. 11 illustrates the display during normal operation, the display of the provisional determination, and the display of the final determination as in FIG. 10.

As illustrated in FIG. 11, when Example 1 of the specific operation is detected, the display of display 40 transitions from the display of the provisional determination to the display of the final determination. Further, as illustrated in FIG. 11, when Example 2 or Example 3 of the specific operation is detected, the display of display 40 transitions from the display of the provisional determination to the display during normal operation.

### Example 1 of Flow of Processing in Present Embodiment

Next, Example 1 of the flow of processing executed in information processing apparatus 10 will be described.

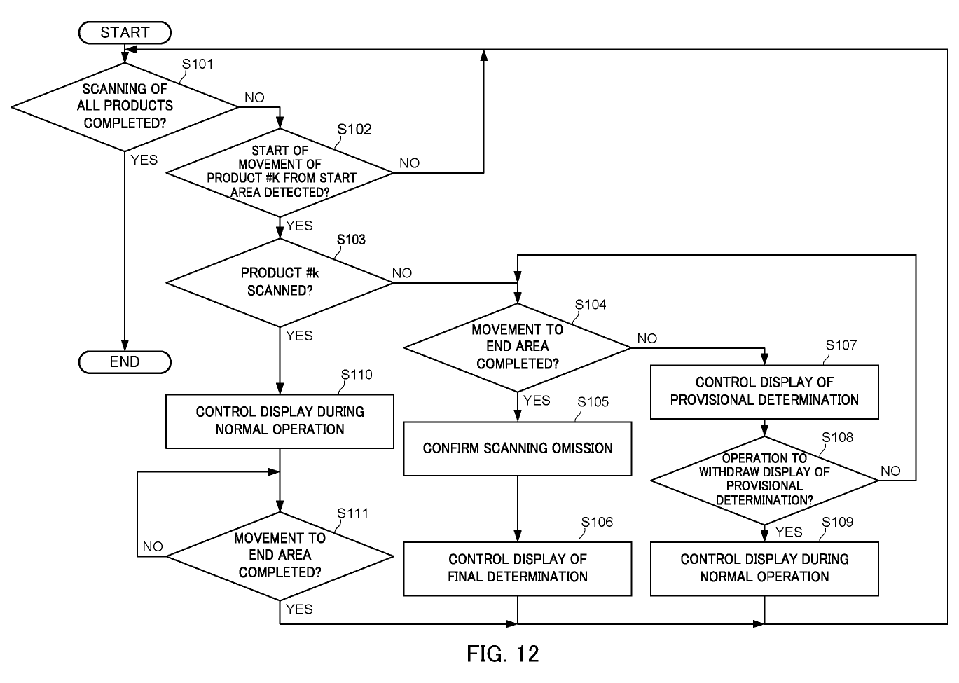

FIG. 12 is a flowchart illustrating Example 1 of the flow of processing executed in information processing apparatus 10. The processing illustrated in FIG. 12 is started, for example, when a customer to perform checkout of a product to be purchased approaches a register and a change in display of display 4 is detected in the camera image or when a product is detected in the camera image. Whether the customer approaches the register may be determined, for example, based on whether a human body appears in the camera image, or may be determined based on a detection result of a human sensor provided in the register. Further, in the processing of FIG. 12, information processing apparatus 10 acquires a camera image and executes the object detection processing and determines the processing state of the register at each predetermined timing. The processing of FIG. 12 is executed based on the result of the object detection processing and the determination result of the processing state of the register.

Information processing apparatus 10 determines whether scanning of all the products to be purchased has been completed (S101). For example, when the processing state of the register indicated by a feature point is the payment standby state, information processing apparatus 10 determines that the scanning of all the products to be purchased has been completed. Further, when the processing state of the register indicated by the feature point is a state other than the payment standby state, information processing apparatus 10 determines that the scanning of all the products to be purchased has not been completed.

When the scanning of all the products is not completed (NO in S101), that is, when there is a product to be purchased (hereinafter, product #k) that has not completed the scanning, information processing apparatus 10 determines whether the movement of the product to be registered from the start area is detected (S102).

When the movement of product #k to be registered is not detected (NO in S102), the flow returns to S101.

When the movement of product #k to be registered is detected (YES in S102), information processing apparatus 10 determines whether scanning of the detected product #k is executed (S103). For example, information processing apparatus 10 determines whether or not the scanning of product #k is executed based on whether the processing state of the register indicated by the feature point is the registration processing state.

When scanning is not executed (NO in S103), information processing apparatus 10 determines whether completion of the movement of product #k to the end area is detected (S104). For example, when the feature point neither indicates the registration processing state nor the manual input standby state, it is determined that the scanning of the product is not executed.

When completion of the movement of product #k to the end area is detected (YES in S104), information processing apparatus 10 determines that scanning omission has occurred (S105). That is, it is determined that shoplifting has occurred. For example, when product #k is moved to the end area and is stationary for a predetermined time, it is determined that the movement of product #k to the end area has been completed. Alternatively, when product #k is moved to the end area and the hand holding product #k is separated from product #k, it is determined that the movement of product #k to the end area has been completed. Alternatively, when product #k is moved to the end area and product #k is stationary for a predetermined time after the hand holding product #k is separated from product #k, it is determined that the movement of product #k to the end area has been completed.

Then, information processing apparatus 10 controls display 40 to display the final determination (S106).

When completion of the movement of product #k to the end area is not detected (NO in S104), information processing apparatus 10 performs the provisional determination that there is a possibility that scanning omission has occurred, and controls display 40 to display the provisional determination (S107).

Information processing apparatus 10 determines whether a specific operation of withdrawing the display of the provisional determination has occurred (S108). The specific operation of withdrawing the display of the provisional determination corresponds to, for example, Example 2 or Example 3 of the specific operation described above.

When the specific operation of withdrawing the display of the provisional determination has occurred (YES in S108), information processing apparatus 10 controls display 40 to withdraw the display of the provisional determination and to display the display during normal operation (S109). Then, the flow returns to S101.

When the specific operation of withdrawing the display of the provisional determination has not occurred (NO in S108), the flow returns to S104, and information processing apparatus 10 determines whether completion of the movement of product #k to the end area is detected (S104). That is, the movement of product #k is tracked until the shoplifting is finally determined or the operation of withdrawing the provisional determination occurs even after the display of the provisional determination is performed.

When the scanning is executed (YES in S103), information processing apparatus 10 controls display 40 to display the display during normal operation (S110).

Next, information processing apparatus 10 determines whether completion of movement of product #k to the end area is detected (S111).

When completion of the movement of product #k to the end area is not detected (NO in S111), the flow returns to S111, and S111 is repeated until the movement of product #k to the end area is completed.

When completion of the movement of product #k to the end area is detected, the flow returns to S101.

When the scanning of all the products is completed (YES in S101), that is, when there is no product to be purchased that has not completed the scanning, the flow illustrated in FIG. 12 ends.

As described above, according to the present embodiment, when there is a possibility that scanning omission of a product occurs between the detection of the passing of the product through the scanning area and the completion of the movement of the product to the end area, it is possible to notify the customer that there is a possibility of scanning omission, thus making it possible to quickly perform the notification of the fraudulent act (e.g., shoplifting) to the customer.

### Variation 1 of Embodiment: Extension of Provisional Determination

In the above-described provisional determination, as illustrated in FIG. 9, it is determined whether there is a possibility of scanning omission between the passing of a product through the scanning area and the detection of the completion of the movement to the end area. Here, an example will be described in which the provisional determination is extended and the alert is issued to the customer even before the product passes through the scanning area.

Here, information processing apparatus 10 determines that the alert is issued to prevent scanning omission from occurring between the detection of the start of the movement of a product in the start area and the detection of the passing of the product through the scanning area.

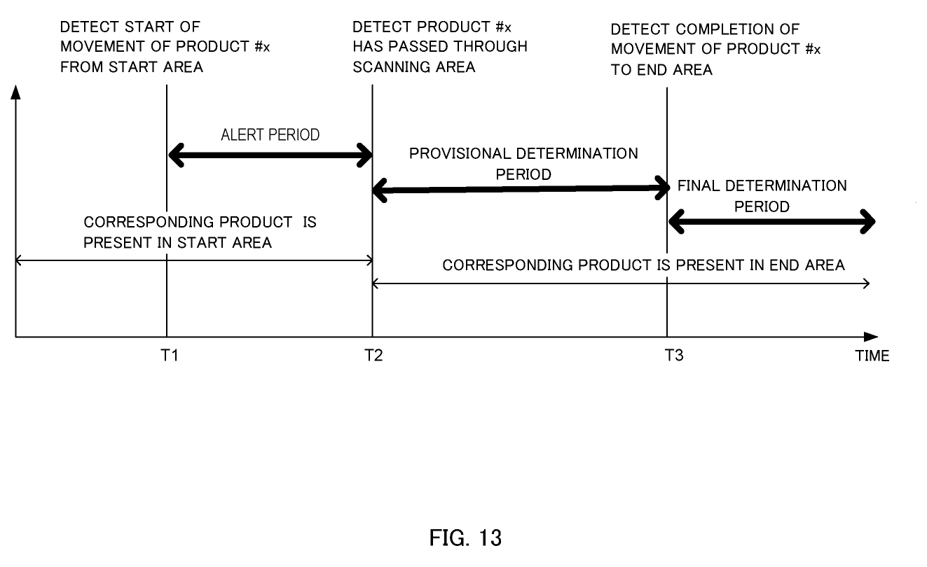

FIG. 13 is a diagram illustrating an example of the extension of the provisional determination. FIG. 13 illustrates an example of a relationship between time and the movement of a product as in FIG. 9. The horizontal axis in FIG. 13 represents the time axis. In the example illustrated in FIG. 13, product #x is stationary in the start area at a time before the point in time T1. The time of the provisional determination and the final determination in FIG. 13 is the same as that in FIG. 9, and thus the description thereof will be omitted.

In the example of FIG. 13, when it is detected at the point in time T1 that the movement of product #x from the start area has started (e.g., product placement table A1a), information processing apparatus 10 determines that the alert is issued. Then, when it is detected at the point in time T2 that product #x has passed through the scanning area set in the vicinity of scanner 2, information processing apparatus 10 withdraws the alert and performs the provisional determination on whether here is a possibility of scanning omission as in the example of FIG. 9.

When it is determined to issue the alert here, information processing apparatus 10 controls display 40 to display the alert. The display of the alert here may be different from the display of the provisional determination and the display of the final determination described above.

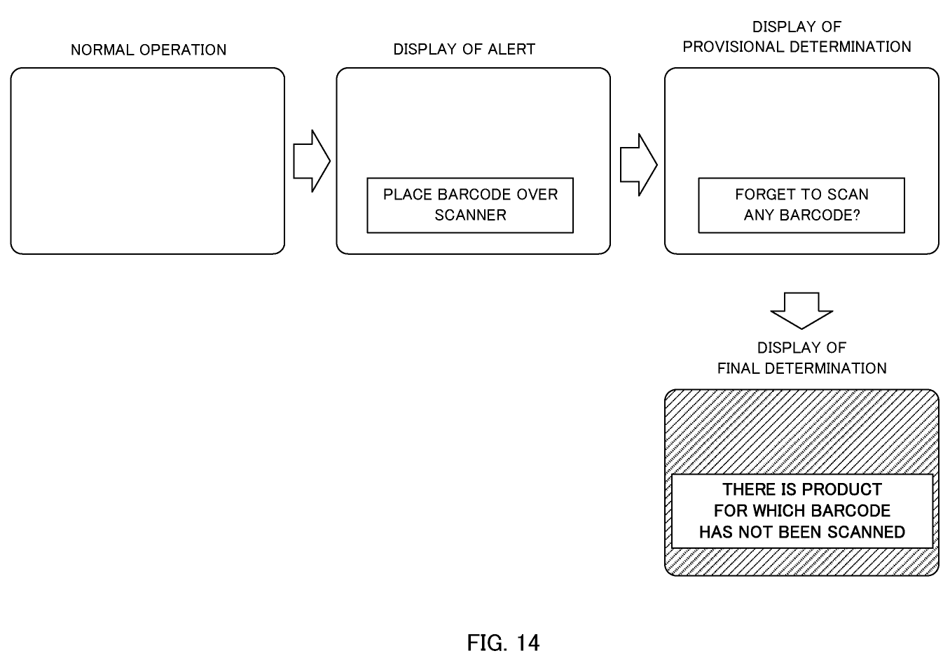

FIG. 14 is a diagram illustrating an example of the display of the alert. FIG. 14 illustrates the display during normal operation, the display of the provisional determination, and the display of the final determination as in FIGS. 10 and 11. Further, FIG. 14 illustrates an example of the display of the alert when the provisional determination is extended.

As illustrated in FIG. 14, in the display of the alert, information to prompt scanning is displayed. In the stage of the alert, since it is not determined whether there is a possibility of scanning omission, the information to intend scanning omission may not be displayed.

### Example of Flow of Processing of Variation 1

Next, an example of the flow of processing executed in information processing apparatus 10 when the extension of the provisional determination described above is applied will be described.

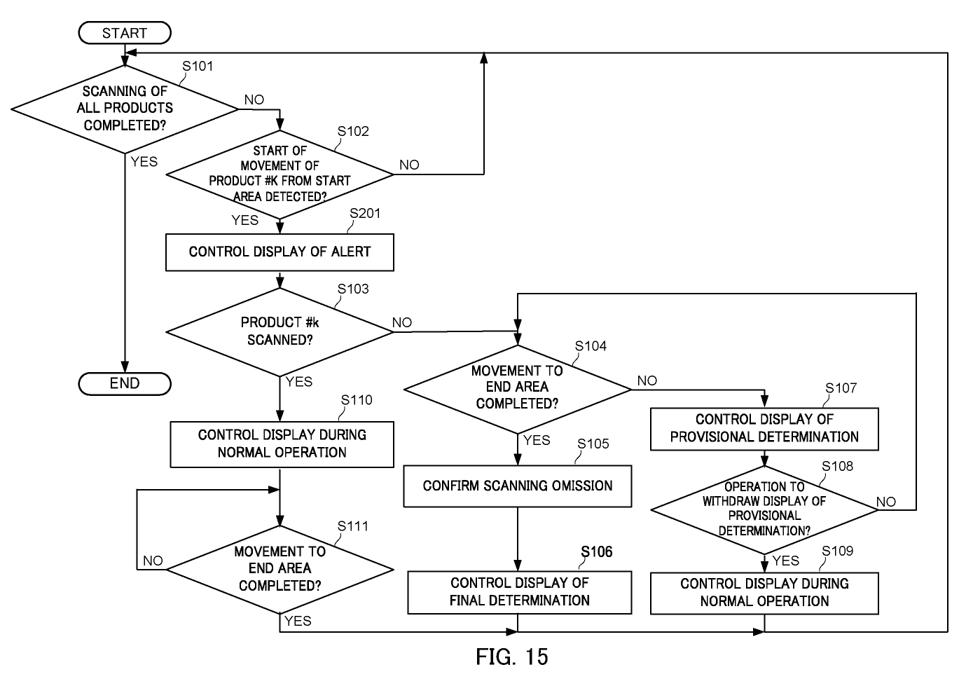

FIG. 15 is a flowchart illustrating Example 2 of the flow of processing executed in information processing apparatus 10. Note that, in FIG. 15, the same processing as in FIG. 12 is denoted by the same reference numerals, and description thereof may be omitted.

In FIG. 15, S201 is added as compared with FIG. 12. As illustrated in FIG. 15, when the movement of product #k to be registered is detected (YES in S102), information processing apparatus 10 controls display 40 to display the alert (S201). Then, information processing apparatus 10 determines whether scanning of the detected product #k has been executed (S103).

As described above, according to Variation 1 of the present embodiment, the alert is issued to the customer to prevent scanning omission from occurring between the detection of the start of the movement of a product in the start area and the detection of the passing of the product through the scanning area, so that it is possible to quickly perform the notification of the fraudulent act (e.g., shoplifting) to the customer.

### Configuration Example of Information Processing Apparatus 10

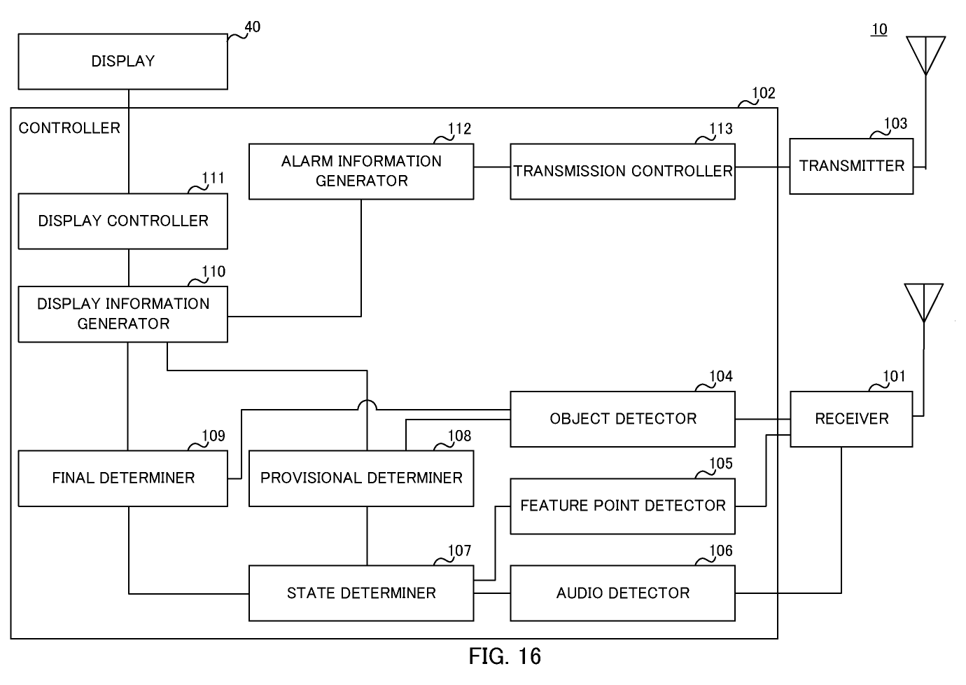

FIG. 16 is a block diagram illustrating a configuration example of information processing apparatus 10. Information processing apparatus 10 illustrated in FIG. 16 includes receiver 101, controller 102, and transmitter 103. Controller 102 includes object detector 104, feature point detector 105, audio detector 106, state determiner 107, provisional determiner 108, final determiner 109, display information generator 110, display controller 111, alarm information generator 112, and transmission controller 113. Controller 102 may be configured by, for example, a processor such as a central processing unit (CPU). For example, each configuration included in controller 102 may be classified into "detector" or "controller" depending on the processing content or the like. For example, at least one of object detector 104, feature point detector 105, audio detector 106, state determiner 107, provisional determiner 108, or final determiner 109 may be referred to as a detector included in controller 102.

Receiver 101 acquires a camera image from camera 20, for example. For example, when camera 20 includes object detection camera 20 and feature point detection camera 20, receiver 101 acquires an object detection camera image captured by object detection camera 20 and a feature point detection camera image captured by feature point detection camera 20. The object detection camera image and the feature point detection camera image may be the same camera image. In other words, camera 20 may capture an image in which a feature point of the screen displayed on display 4 can be detected and a product moved by a customer can be detected.

Further, receiver 101 may acquire audio from microphone 30.

Object detector 104 detects an object based on a camera image (e.g., object detection camera image). For example, object detector 104 detects what product is held by the customer and/or what product is carried and moved by the customer from the camera image. Object detector 104 outputs object detection information related to the detected object to provisional determiner 108. Object detection information includes information indicating whether object detector 104 has detected an object. Further, when object detector 104 detects the object, the object detection information may include information indicating what the detected object is. Further, when object detector 104 detects the start of movement of the object, the object detection information may include information indicating a timing of the start of the movement of the detected object. Further, the object detection information may include a movement direction of the detected object, a movement destination, a position at which the movement is completed, and the like. For example, object detector 104 may detect which region, such as the start area or the end area, the product has moved to, and the detection result may be included in the object detection information.

Object detector 104 may detect whether the customer holds an object instead of detecting what product is held by the customer in the object detection processing. Alternatively, object detector 104 may detect whether the customer performs the behavior of moving while holding the object instead of detecting what product is carried and moved by the customer. In other words, in the object detection processing, the detection (recognition) of what the object is may not be performed. In this case, the object detection information may include information indicating whether the customer holds an object and/or information indicating whether the customer performs the behavior of moving while holding an object. Further, object detector 104 may perform the object detection processing based on other information instead of the camera image (e.g., object detection camera image).

Feature point detector 105 detects a feature point of the camera image. For example, feature point detector 105 detects the feature point of the image indicating the processing state of the register corresponding to the display of display 4 and outputs image feature point information indicating the detected image feature point to state determiner 107.

Audio detector 106 detects the audio or the like generated when the product is scanned based on the audio captured by microphone 30.

State determiner 107 determines the processing state of the register corresponding to the display of display 4. For example, state determiner 107 determines the processing state of the register corresponding to the display based on the image feature point information. Alternatively, when the audio generated when the product is scanned is detected, state determiner 107 may determine that the processing state of the register is the registration processing state. The processing state of the register to be determined is, for example, at least one of the states illustrated in FIG. 3 or the like. The determination and the detection may be replaced with each other.

Provisional determiner 108 performs the provisional determination on whether there is a possibility that scanning omission occurs. For example, provisional determiner 108 performs the provisional determination on whether there is a possibility that scanning omission occurs based on the processing state of the register determined by state determiner 107 and the object detection information acquired from object detector 104. For example, when the object detection information indicates that the product has passed through the peripheral area of scanner 2 and has moved to the end area, and the operation state related to the payment indicates that the product is not in a state of being registered, provisional determiner 108 determines that there is a possibility that scanning omission occurs. Here, the peripheral area will be described as being the same area as the start area, but the peripheral area and the start area do not have to completely match. For example, a part of the start area close to the end area may be used as the peripheral area. Further, for example, when the object detection information indicates that the product has passed through the peripheral area of scanner 2 and has moved to the end area, and the operation state related to the payment indicates that the product is in a state of being registered, provisional determiner 108 determines that there is no possibility that scanning omission occurs.

Provisional determiner 108 may withdraw the provisional determination that there is a possibility that scanning omission occurs when the specific operation is detected after the provisional determination that there is a possibility that scanning omission occurs is made.

Further, provisional determiner 108 may determine whether there is an operation for the alert of scanning omission. For example, when the object detection information indicates that the movement of a product from the start area is started and the product is in a state of passing through the peripheral area of scanner 2, provisional determiner 108 determines that the operation for the alert of scanning omission is being performed. In other words, when it is detected that the movement of the product from the start area is started and the product passes through the scanning area to be scanned, provisional determiner 108 determines that the operation for the alert of scanning omission is being performed.

Final determiner 109 performs the final determination on whether scanning omission has occurred. The final determination on whether scanning omission has occurred corresponds to the determination on whether "shoplifting" has occurred. For example, final determiner 109 performs the final determination on whether or not scanning omission has occurred based on the processing state of the register determined by state determiner 107 and the object detection information acquired from object detector 104. For example, when the object detection information indicates completion of the movement of a product to the end area, and the operation state related to the payment indicates that the product is not in a state of being registered, final determiner 109 determines that scanning omission has occurred. For example, when the object detection information indicates completion of the movement of the product to the end area, and the operation state related to the payment indicates that the product is in a state of being registered, final determiner 109 determines that scanning omission has not occurred.

Display information generator 110 generates information to be displayed based on the result of the determination in provisional determiner 108 and/or the result of the determination in final determiner 109. Display information generator 110 generates display information of the provisional determination when provisional determiner 108 determines that there is a possibility that scanning omission occurs. Display information generator 110 generates an instruction to withdraw the display information of the provisional determination when provisional determiner 108 determines to withdraw the provisional determination that there is a possibility that scanning omission occurs. Display information generator 110 generates display information of the alert when provisional determiner 108 determines that the operation for the alert of scanning omission is being performed. Display information generator 110 generates display information of the final determination when final determiner 109 determines that scanning omission has occurred.

Further, display information generator 110 may extract a product image of the product for which scanning omission has occurred from a camera image when final determiner 109 determines that scanning omission has occurred.

Further, display information generator 110 does not generate information to be displayed when final determiner 109 determines that scanning omission has not occurred and when provisional determiner 108 determines that there is no possibility that scanning omission has occurred.

Display controller 111 controls the display of display 40 provided in the register. For example, display controller 111 displays information on display 40 in accordance with the display information generated by display information generator 110 or an instruction.

Alarm information generator 112 generates alarm information indicating an alarm for issuing a warning of shoplifting when final determiner 109 determines that scanning omission has occurred. In this case, the alarm information may include a product image of the product for which scanning omission has occurred, which is extracted by display information generator 110.

Transmission controller 113 generates transmission information including the alarm information, and transmits the transmission information via transmitter 103. The transmission information may be transmitted to, for example, a terminal owned by the staff or the security guard of the store, or may be transmitted to a display device checked by the staff or the security guard of the store. The staff or the security guard of the store may check the transmitted alarm information and may perform a response such as a warning to the customer who has a possibility of performing shoplifting. Further, the transmission information may be transmitted to, for example, a display device or the like that is present at a location other than the store, such as a display device for monitoring shoplifting at a remote location.

In the present embodiment, an example has been described in which information processing apparatus 10 provided in each of the self-checkout register systems performs the object detection processing, the provisional determination, and the final determination, but the present disclosure is not limited to this. At least one of the object detection processing, the provisional determination, or the final determination may be executed by another device such as store terminal 200 or a server provided in the store. For example, when the object detection processing is executed by another device, information processing apparatus 10 transmits the camera image or the like to the other device (e.g., store terminal 200, server provided in the store, or the like), and acquires the result of the object detection processing from the other device.

Further, in the embodiment described above, information processing apparatus 10 (e.g., object detector 104) detects the movement of a product using a camera image. However, the movement of a product may be detected by another means. For example, information processing apparatus 10 may detect the movement of a product based on a change in weight detected by a weight sensor provided in product placement table A1a and product placement table A1b. Further, for example, a wireless tag such as an RFID may be attached to the product, and information processing apparatus 10 may detect the movement of the product by detecting the movement of the wireless tag of the product. Further, information processing apparatus 10 may detect the movement of a product by using the object detection camera image and the detection result of the weight sensor or the wireless tag in combination. In this case, information processing apparatus 10 may detect to which area the product has moved and may determine whether the movement of the product has been completed, based on the detection result of the weight sensor or the wireless tag. For example, when the weight detected from product placement table A1a is reduced, it may be determined that the movement of the product has started, and when the weight detected from product placement table A1b is increased, it may be determined that the movement of the product has been completed. Further, it may be determined to which area the product has moved to based on the position of the product detected by the wireless tag. Here, when information processing apparatus 10 is configured to acquire information indicating that the scanning is performed when scanner 2 scans a product, the same operation as that of the embodiment described above can be realized without using a camera image.

Further, in the embodiment described above, information processing apparatus 10 determines the processing state of the register corresponding to the display of display 4 by detecting a feature point of the image. However, information processing apparatus 10 may determine the processing state of the register using another method such as recognizing the characters displayed on display 4 or using pattern matching of the entire image displayed on display 4.

Object detector 104 (an example of a detector) of controller 102 of information processing apparatus 10 described above detects to which region a product (an example of an article) has moved during an operation in which a customer moves the product from a start area (an example of a first region) to a scanning area (an example of a second region) to scan the product and moves the product from the scanning area to an end area. Display controller 110 (an example of a controller) performs display control for performing display of the provisional determination (an example of the presentation of information to the customer) until completion of movement of the product to the end area is detected when it is detected that the customer has not scanned the product in the scanning area.

Note that the notation of "... section," "…unit" and/or "a term with a suffix of -er or -or" in the above-described embodiment may be replaced with another notation such as " ... circuitry", " ... device", " ... unit", or " ... module".

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is collectively referred to as a communication apparatus. Some non-limiting examples of such a communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine prescription) device, and a vehicle provided with communication functions or transportation means (e.g., automotive, airplane, ship), and combinations of various kinds of apparatuses described above.

The communication apparatus is not limited to be portable or movable, and may also include any kind of apparatus, device or system being not portable or stationary, such as a smart home device (e.g., an appliance, lighting, smart meter or measurement device, control panel), a vending machine, and any other "things" in a network of an "Internet of Things (IoT)."

The communication may include exchanging data through, for example, a cellular system, a wireless LAN system, a satellite system, etc., and various combinations thereof.

The communication apparatus may include a device such as a controller or a sensor which is coupled to a communication device performing a function of communication described in the present disclosure. For example, the communication apparatus may include a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

Although various embodiments have been described above with reference to the drawings, it is needless to say that the present disclosure is not limited to such example. It is apparent that those skilled in the art may arrive at various modifications or variations at within the scope of the claims, and it is naturally understood that they are also within the technical scope of the present disclosure. Further, any combination of component elements in the above-mentioned embodiment may be made without departure from the spirit of the present disclosure.

The specific examples of the present disclosure have been described in detail above, but these specific examples are mere examples and do not limit the appended claims. The technology described in the appended claims embraces various modifications and changes made in accordance with the specific examples described above.

### INDUSTRIAL APPLICABILITY

The present disclosure is useful for detecting a fraudulent act in self-checkout registers.

### REFERENCE SIGNS LIST

1, 10 Information processing apparatus
2 Scanner
3, 20 Camera
30 Microphone
4, 40 Display
A1a, A1b Product placement table
101 Receiver
102 Controller
103 Transmitter
200 Store terminal

1. An information processing apparatus, comprising:
a detector, which in operation, detects to which region an article has moved during an operation in which a customer moves the article placed in a first region to a second region, registers the article at a registration apparatus, and moves the article from the second region to a third region; and
a controller, which in operation, performs, when it is detected that the customer has not registered a first article in the second region, control that presents first information to the customer until completion of movement of the first article to the third region is detected.

2. The information processing apparatus according to claim 1, wherein,
the information processing apparatus acquires an image resulting from capturing the operation of the customer, and
the detector detects, in the image, whether the customer has registered the first article.

3. The information processing apparatus according to claim 1, wherein, the controller performs control that presents second information different from the first information, when the controller detects that the customer has not registered the first article in the second region and when completion of the movement of the first article to the third region is detected.

4. The information processing apparatus according to claim 3, wherein the controller performs, when it is detected that the customer has started moving the first article from the first region, control that presents third information different from the first information and the second information until it is detected that the customer does not register the first article or registers the first article in the second region.

5. The information processing apparatus according to claim 1, wherein, the controller does not present the first information to the customer when it is detected that the customer has registered the first article in the second region.

6. The information processing apparatus according to claim 1, wherein, the controller stops presenting the first information to the customer when it is detected that the customer has not registered the first article in the second region and when a specific operation is detected before completion of the movement of the first article to the third region is detected.

7. The information processing apparatus according to claim 6, wherein, the specific operation is at least one of an operation in which the customer moves the first article to the first region or the second region, and an operation in which the customer moves the first article to a region different from any of the first region, the second region, and the third region.

8. The information processing apparatus according to claim 1, wherein, the controller does not output, when it is detected that the registration apparatus is in a state where registration of the article is not allowed, the first information even when it is detected that the customer has not registered the first article in the second region.

9. A control method, comprising:
detecting, by an information processing apparatus, to which region an article has moved during an operation in which a customer moves the article placed in a first region to a second region, registers the article at a registration apparatus, and moves the article from the second region to a third region; and
performing, by the information processing apparatus, when it is detected that the customer has not registered a first article in the second region, control that presents first information to the customer until completion of movement of the first article to the third region is detected.
